(19) United States
(12) Patent Application Publication
(10) Pub. No.: US 2011/0221645 A1
(43) Pub. Date: Sep. 15, 2011

(54) ANTENNA ASSEMBLIES AND METHODS OF MANUFACTURE THEREOF

(75) Inventors: Najed Azzam, Nazareth (IL); Ruvim Goldman, Nazareth Illit (IL); Eli Gelbart, Holon (IL)

(73) Assignee: GALTRONICS CORPORATION LTD., Tiberias (IL)

(21) Appl. No.: 13/124,331

(22) PCT Filed: Nov. 1, 2009
(86) PCT No.: PCT/IL09/01018

§ 371 Date: May 24, 2011

Related U.S. Application Data
(60) Provisional application No. 61/198,026, filed on Oct. 30, 2008.

(51) Int. Cl. H01Q 1/38; H01Q 19/06; H01Q 13/10; B32B 37/12; B32B 37/14

(52) U.S. Cl. 343/770; 343/700 MS; 343/833; 156/60

(57) ABSTRACT

A method of manufacturing antennas including forming at least one conductive antenna array pattern having an antenna feed network on at least a first relatively flexible substrate and adhering the at least one flexible substrate to at least one first surface of at least one relatively rigid substrate.

### REFERENCE TO RELATED APPLICATIONS

Reference is made to U.S. Provisional Patent Application Ser. No. 61/198,026 filed Oct. 30, 2008 and entitled LOW COST ANTENNA ARRAY MANUFACTURING METHOD, the disclosure of which is hereby incorporated by reference and priority of which is hereby claimed pursuant to 37 CFR 1.78(a) (4) and (5)(i).

### FIELD OF THE INVENTION

The present invention relates to antennas and more particularly to methods for manufacturing antennas.

### BACKGROUND OF THE INVENTION

The following U.S. patent publications are believed to represent the current state of the art: U.S. Pat. No. 6,947,008, U.S. Pat. No. 6,822,616, U.S. Pat. No. 6,703,114 and U.S. Pat. No. 5,614,915.

### SUMMARY OF THE INVENTION

The present invention seeks to provide improved methods for manufacturing antennas. There is thus provided in accordance with a preferred embodiment of the present invention a method of manufacturing antennas including forming at least one conductive antenna array pattern having an antenna feed network on at least a first relatively flexible substrate and adhering the at least one flexible substrate to at least one first surface of at least one relatively rigid substrate.

In accordance with a preferred embodiment of the present invention the method also includes forming at least one conductive antenna array pattern having a plurality of antenna radiators on at least a second relatively flexible substrate.

In accordance with a preferred embodiment of the present invention the method also includes adhering the at least second flexible substrate to at least one second surface of the at least one relatively rigid substrate.

In accordance with a preferred embodiment of the present invention the method also includes mounting the at least one relatively rigid substrate having adhered thereto the at least first flexible substrate onto a dielectric support.

In accordance with a preferred embodiment of the present invention the method also includes mounting the at least one relatively rigid substrate having adhered thereto the at least first and second flexible substrates onto a dielectric support.

Preferably, the at least first flexible substrate is adhered to the at least one first surface of the at least one relatively rigid substrate by means of an adhesive undersurface.

In accordance with a preferred embodiment of the present invention the method also includes the forming of apertures in the at least one relatively rigid substrate and the at least first flexible substrate for mounting thereof on the dielectric support.

There is also provided in accordance with another preferred embodiment of the present invention an antenna assembly including at least one first relatively rigid substrate and at least one first flexible substrate, bearing thereon at least one first antenna array including an antenna feed network, adhered to the at least one first relatively rigid substrate.

In accordance with a preferred embodiment of the present invention the antenna assembly also includes at least one second relatively rigid substrate, at least one second flexible substrate, bearing thereon at least one second antenna array, adhered to the at least one second relatively rigid substrate and a dielectric spacer element supporting the at least first relatively rigid substrate and the at least second relatively rigid substrate in mutually spaced registration.

In accordance with a preferred embodiment of the present invention the antenna assembly also includes at least one third flexible substrate bearing thereon at least one third antenna array, adhered to the at least one first relatively rigid substrate.

Preferably, the antenna assembly also includes a ground plane supported by the dielectric spacer element.

In accordance with a preferred embodiment of the present invention the antenna assembly also includes coaxial feed connectors mounted onto the at least one first flexible substrate and the at least one first relatively rigid substrate.

In accordance with a preferred embodiment of the present invention an adhesive undersurface of the at least one first flexible substrate adheres the at least one first flexible substrate to the at least one first relatively rigid substrate. Additionally, an adhesive undersurface of the at least one second flexible substrate adheres the at least one second flexible substrate to the at least one second relatively rigid substrate. Additionally, an adhesive undersurface of the at least one third flexible substrate adheres the at least one third flexible substrate to the at least one first relatively rigid substrate.

Preferably, the at least one second antenna array includes an antenna director. Additionally, the at least one third antenna array includes a slot array.

### BRIEF DESCRIPTION OF THE DRAWINGS

The present invention will be understood and appreciated more fully from the following detailed description, taken in conjunction with the drawings in which:

FIG. 1 is a simplified pictorial illustration a series of steps in the manufacture of an antenna assembly in accordance with a preferred embodiment of the present invention;

FIGS. 2A & 2B are together a simplified pictorial illustration of an additional series of steps in the method of manufacture of an antenna assembly in accordance with a preferred embodiment of the present invention;

FIGS. 3A and 3B are simplified pictorial exploded views taken from respective opposite directions of an antenna assembly employing antennas of the types produced in accordance with the steps illustrated in FIGS. 1 and 2A & 2B;

FIG. 4 is a simplified pictorial assembled view of the antenna assembly of FIGS. 3A & 3B; and

FIGS. 5A and 5B are respective pictorial/sectional illustrations of the antenna assembly of FIGS. 3A, 3B & 4, taken along respective lines VA-VA and VB-VB.

### DETAILED DESCRIPTION OF PREFERRED EMBODIMENTS

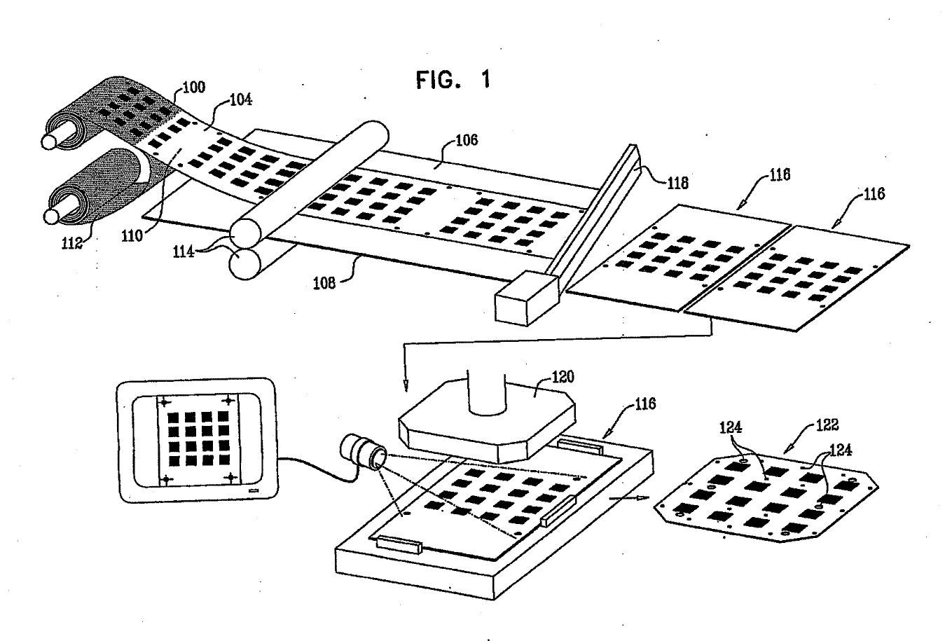

Reference is now made to FIG. 1, which is a simplified pictorial illustration of steps in a method of manufacturing an antenna assembly in accordance with a preferred embodiment of the present invention. As seen in FIG. 1, the method includes forming by conventional techniques such as photolithography or metal deposition at least one conductive antenna array pattern 100 including an antenna director pattern on at least one relatively flexible substrate, here preferably a substrate 104 formed of Lexan 8010 polycarbonate film manufactured by Sabic of Pittsfield Mass., USA, and adhering the flexible substrate 104 to at least one surface 106 of at least one relatively rigid substrate, here preferably a substrate 108 formed of Formex GK-40 manufactured by ITWFormex of Addison Ill., USA.

As seen in FIG. 1, the substrate 104 bearing pattern 100 is preferably provided with an adhesive engagement undersurface 110. Adhesive undersurface 110 is preferably provided by adhering of 3M 9471 double-sided tape including a release layer 112, manufactured by 3M, to the underside of substrate 104. The release layer 112 is separated from undersurface 110 of substrate 104 just prior to engagement of undersurface 110 with surface 106 of substrate 108. The fixed attachment of substrate 104 onto surface 106 of substrate 108 is preferably facilitated by operation of squeeze rollers 114. Individual antenna director array assembly precursors 116 are defined by cutting the attached substrates 104 and 108 as by a knife 118. Following optical alignment of precursors 116, the precursors are die cut, as by a die cutter 120, to define antenna director array assemblies 122 having alignment apertures 124.

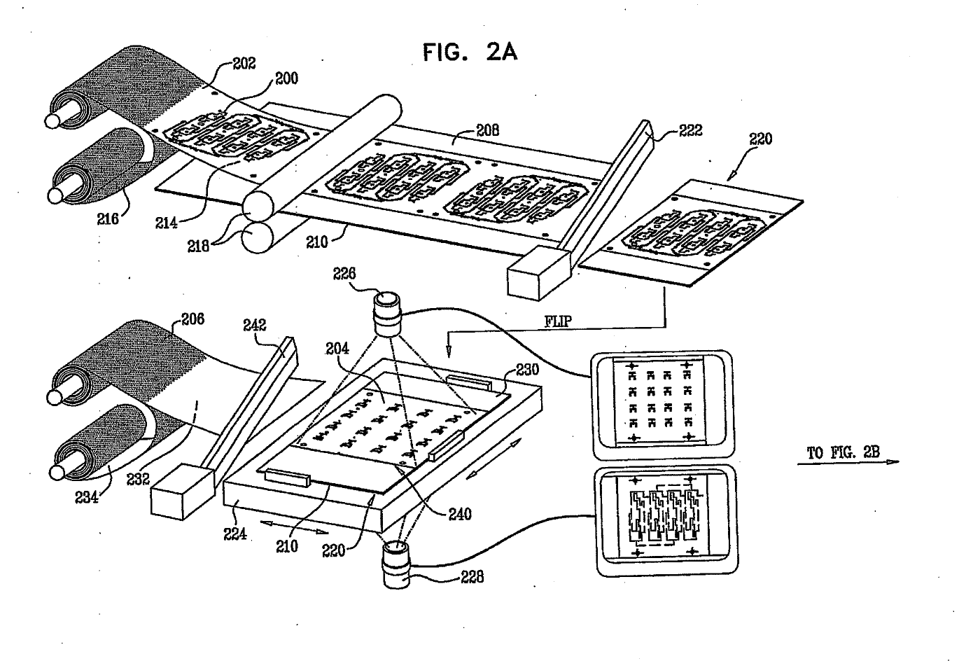

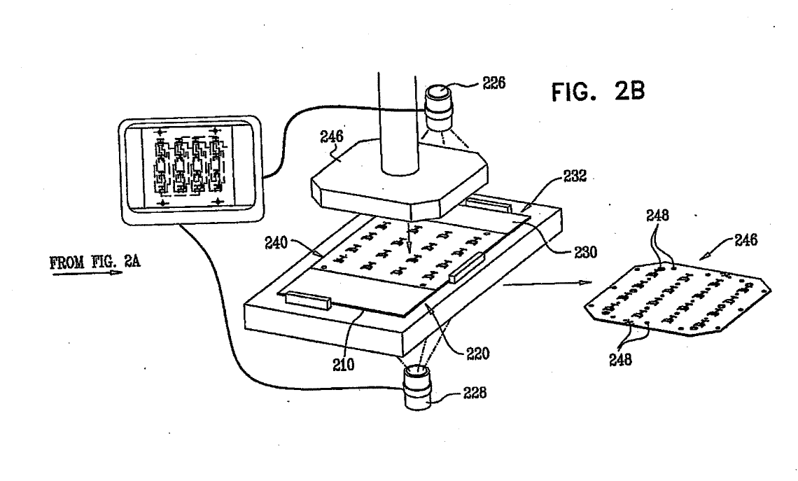

Reference is now made to FIGS. 2A & 2B, which are together a simplified pictorial illustration of additional steps in a method of manufacturing an antenna assembly in accordance with a preferred embodiment of the present invention.

As seen in FIGS. 2A & 2B, at least one conductive antenna array pattern 200, preferably defining an antenna feed network, is formed on at least a first relatively flexible substrate, here preferably a substrate 202 formed of Lexan 8010 polycarbonate film manufactured by Sabic of Pittsfield Mass., USA.

At least one conductive antenna array pattern 204, preferably a slot array defining a plurality of antenna radiators, is formed by conventional techniques on at least a second relatively flexible substrate, here preferably a substrate 206 formed of Lexan 8010 polycarbonate film manufactured by Sabic of Pittsfield Mass., USA.

As seen in FIGS. 2A & 2B, the substrate 202 bearing pattern 200 is preferably supplied with an adhesive engagement undersurface 214. Adhesive undersurface 214 is preferably provided by adhering of 3M 9471 double-sided tape including a release layer 216, manufactured by 3M, to the underside of substrate 202. The release layer 216 is separated from undersurface 214 of substrate 202 just prior to engagement of undersurface 214 with surface 208 of at least one relatively rigid substrate, here preferably a substrate 210 formed of Formex GK-40 manufactured by ITWFormex of Addison Ill., USA. The fixed attachment of substrate 202 onto surface 208 of substrate 210 is preferably facilitated by operation of squeeze rollers 218.

Individual assembly precursors 220 are defined by cutting the attached substrates 202 and 210 as by a knife 222. The individual precursors 220 are preferably flipped over onto a transparent registration fixture 224 having optical inspection subsystems 226 and 228 arranged respectively above and below the fixture 224, such that a surface 230 of substrate 210 faces upwardly, as shown.

As seen in FIGS. 2A & 2B, the substrate 206 bearing pattern 204 is preferably supplied with an adhesive engagement undersurface 232. Adhesive undersurface 232 is preferably provided by adhering of 3M 9471 double-sided tape including a release layer 234, manufactured by 3M, to the underside of substrate 206. The release layer 234 is separated from undersurface 232 of substrate 206 just prior to engagement of undersurface 232 with surface 230 of substrate 210. Individual slot array precursors 240 may be cut from substrate 206 as by a knife 242.

Following mutual optical alignment of the precursors 220 and 240, provided using optical inspection subsystems 226 and 228, the precursor 240 is adhered to surface 230 of substrate 210 of precursor 220, preferably facilitated by operation of squeeze rollers (not shown) and subsequently cut, as by a die cutter 246 to define individual slot array/feed network assemblies 246 having alignment apertures 248.

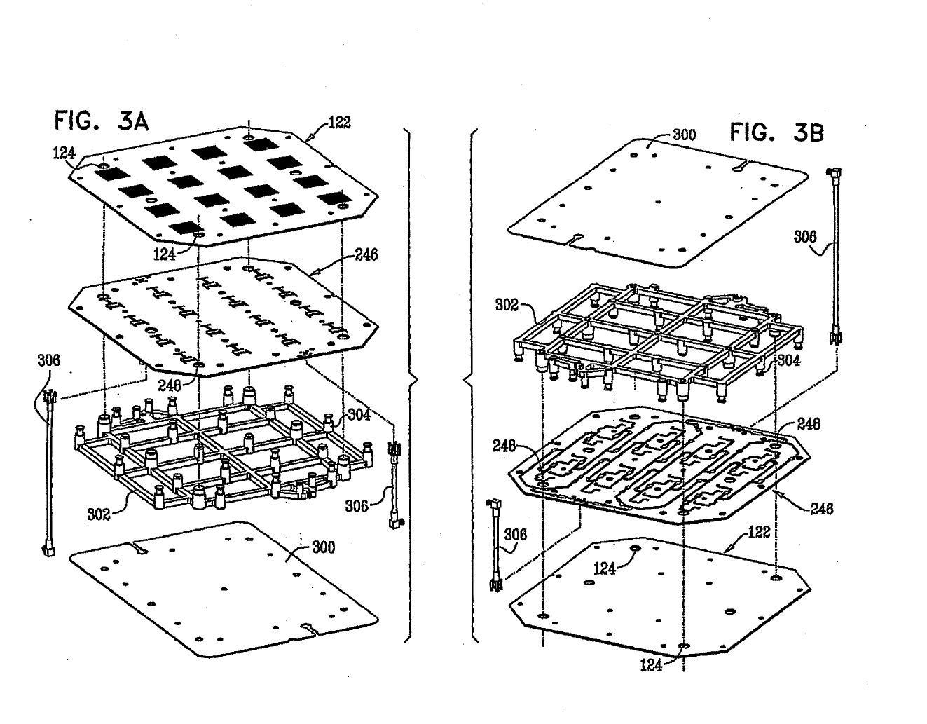

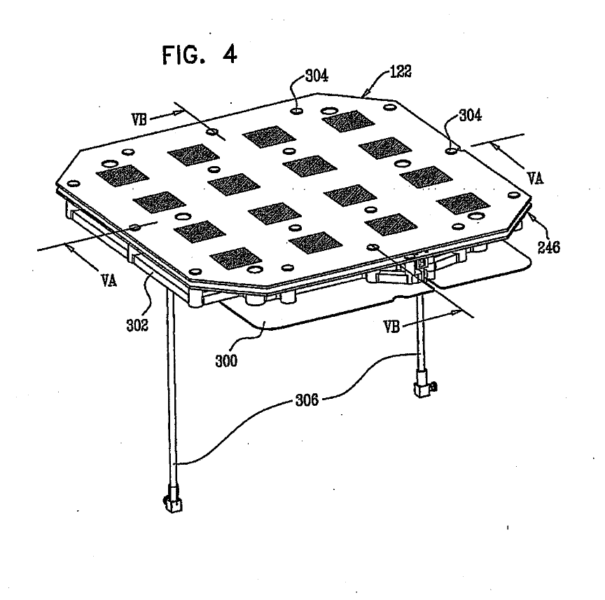

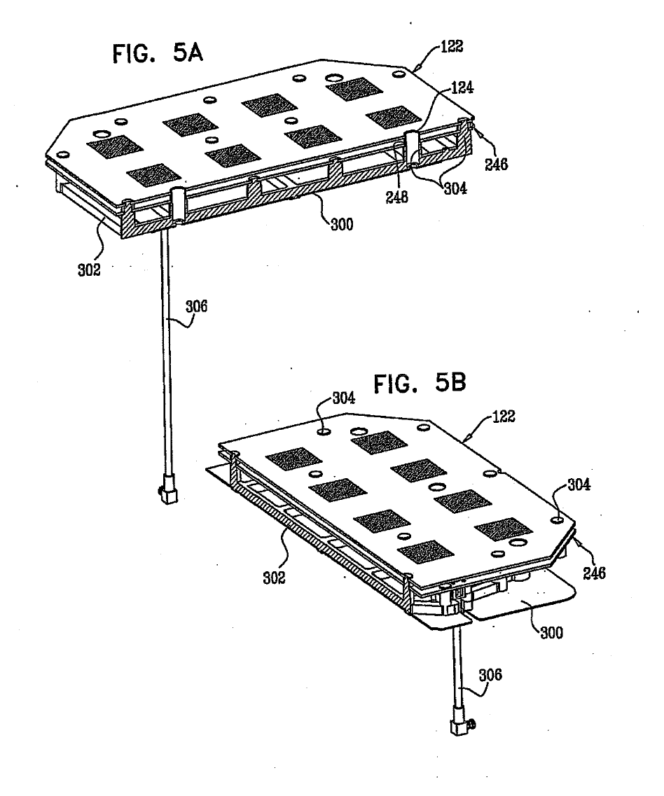

Reference is now made to FIGS. 3A and 3B, which are simplified pictorial exploded views taken from respective opposite directions of an antenna assembly employing antennas of the types produced in accordance with the methods illustrated in FIGS. 1 and 2A & 2B; to FIG. 4, which is a simplified pictorial assembled view of the antenna assembly of FIGS. 3A & 3B; and to FIGS. 5A and 5B, which are respective pictorial/sectional illustrations of the antenna assembly of FIGS. 3A, 3B & 4, taken along respective lines VA-VA and VB-VB.

As seen in FIGS. 3A and 3B, an antenna director array assembly 122 and a slot array/feed network assembly 246 are mounted in predetermined spaced mutual registration together with a ground plane 300 by means of a dielectric spacer 302. Spacer 302 includes a plurality of vertical elements 304 which extend through alignment apertures 124 in assembly 122 and alignment apertures 248 in assembly 246 to ensure alignment of assemblies 122 and 246. Coaxial feed connectors 306 are preferably mounted onto the slot array/feed network assembly 246 at antenna feed locations thereon.

Typical spacing between assemblies 122 and 246 is preferably 3 mm. Typical spacing between assembly 246 and ground plane 300 is preferably 11 mm.

It will be appreciated by persons skilled in the art that the present invention is not limited to what has been particularly shown and described hereinabove. Rather the scope of the invention includes both combinations and subcombinations of the various features described hereinabove as well as modifications and variations thereof which would occur to persons skilled in the art upon reading the foregoing description and which are not in the prior art.

1. A method of manufacturing antennas comprising:
forming at least one conductive antenna array pattern having an antenna feed network on at least a first relatively flexible substrate; and
adhering said at least one flexible substrate to at least one first surface of at least one relatively rigid substrate.

2. A method according to claim 1 and including forming at least one conductive antenna array pattern having a plurality of antenna radiators on at least a second relatively flexible substrate.

3. A method according to claim 2 and including adhering said at least second flexible substrate to at least one second surface of said at least one relatively rigid substrate.

4. A method according to claim 1 and including mounting said at least one relatively rigid substrate having adhered thereto said at least first flexible substrate onto a dielectric support.

5. A method according to claim 3 and including mounting said at least one relatively rigid substrate having adhered thereto said at least first and second flexible substrates onto a dielectric support.

6. A method according to claim 1 and wherein said at least first flexible substrate is adhered to said at least one first surface of said at least one relatively rigid substrate by means of an adhesive undersurface.

7. A method according to claim 4 and including the forming of apertures in said at least one relatively rigid substrate and said at least first flexible substrate for mounting thereof on said dielectric support.

8. An antenna assembly comprising:
at least one first relatively rigid substrate; and
at least one first flexible substrate bearing thereon at least one first antenna array including an antenna feed network, adhered to said at least one first relatively rigid substrate.

9. An antenna assembly according to claim 8 and also comprising:
at least one second relatively rigid substrate;
at least one second flexible substrate bearing thereon at least one second antenna array, adhered to said at least one second relatively rigid substrate;
a dielectric spacer element supporting said at least first relatively rigid substrate and said at least second relatively rigid substrate in mutually spaced registration.

10. An antenna assembly according to claim 9 and also comprising at least one third flexible substrate bearing thereon at least one third antenna array, adhered to said at least one first relatively rigid substrate.

11. An antenna assembly according to claim 9 and also comprising a ground plane supported by said dielectric spacer element.

12. An antenna assembly according to claim 8 and also comprising coaxial feed connectors mounted onto said at least one first flexible substrate and said at least one first relatively rigid substrate.

13. An antenna assembly according to claim 8 and wherein an adhesive undersurface of said at least one first flexible substrate adheres said at least one first flexible substrate to said at least one first relatively rigid substrate.

14. An antenna assembly according to claim 9 and wherein an adhesive undersurface of said at least one second flexible substrate adheres said at least one second flexible substrate to said at least one second relatively rigid substrate.

15. An antenna assembly according to claim 10 and wherein an adhesive undersurface of said at least one third flexible substrate adheres said at least one third flexible substrate to said at least one first relatively rigid substrate.

16. An antenna assembly according to claim 9 and wherein the at least one second antenna array comprises an antenna director.

17. An antenna assembly according to claim 10 and wherein the at least one third antenna array comprises a slot array.

18. A method according to claim 5 and including the forming of apertures in said at least one relatively rigid substrate and said at least first flexible substrate for mounting thereof on said dielectric support.

19. An antenna assembly according to claim 10 and also comprising a ground plane supported by said dielectric spacer element.
